(19) United States
(12) Patent Application Publication
(10) Pub. No.: US 2003/0075584 A1
(43) Pub. Date: Apr. 24, 2003

(54) Method and apparatus for friction stir welding

(76) Inventors: Daniel J. Sarik, Katy, TX (US); David K. Truax, Houston, TX (US)

Correspondence Address: Rosenthal & Osha L.L.P., 1221 McKinney, Suite 2800, Houston, TX, 77010, US

(21) Appl. No.: 10/265,084

(22) Filed: Oct. 4, 2002

Related U.S. Application Data
(60) Provisional application No. 60/327,198, filed on Oct. 4, 2001.

(51) Int. Cl. B23K 20/12; B23K 31/02

(52) U.S. Cl. 228/2.1; 228/112.1

(57) ABSTRACT

In one embodiment, an apparatus for use in friction stir welding including a friction stir tool, having a shoulder, a non-consumable welding pin extending downward centrally from the shoulder, a first workpiece disposed on a backing workpiece, a second workpiece located a predetermined distance from the first workpiece on the backing workpiece, and a transition strip disposed on the backing workpiece between the first workpiece and the second workpiece, wherein the contact area or a space between the transition strip and the first workpiece defines a first interface and the contact area or a space between the transition strip and the second workpiece defines a second interface, wherein the non-consumable welding pin is rotated over the first interface and the second interface to weld the first workpiece to the second workpiece with the transition strip material incorporated as part of the weld, is disclosed.

### CROSS-REFERENCE TO RELATED APPLICATIONS

This application claims the benefit of U.S. Provisional Patent Application No. 60/327,198 filed on Oct. 4, 2001.

### BACKGROUND OF THE INVENTION

1. Field of the Invention

The invention relates generally to methods and apparatus for friction stir welding.

2. Background Art

Friction stir welding (“FSW”) is a technology that has been developed for welding metals, metal alloys, and other materials. The friction stir welding process generally involves engaging the material of two adjoining workpieces on either side of a joint by a rotating stir pin or spindle. Force is exerted to urge the spindle and the workpieces together, and frictional heating caused by the interaction between the spindle and the workpieces results in plasticization of the material on either side of the joint. The spindle is traversed along the joint, plasticizing material as it advances, and the plasticized material left in the wake of the advancing spindle cools and solidifies to form a weld.

It will be appreciated that large forces must be exerted between the spindle and the workpieces in order to apply sufficient pressure to the workpieces to cause plasticization of the material. For instance, for friction stir welding an aluminum alloy workpiece of ¼-inch thickness, forces of up to 4000 pounds or more may have to be exerted between the spindle and the workpiece. In a conventional friction stir welding process, these large forces are absorbed at least partially by a back-up member which engages the workpieces on the “back side” of the weld opposite the spindle. Where the workpieces have sufficient structural strength and rigidity, some of the force may be absorbed by the workpieces themselves. However, in many cases the workpieces are semi-flexible structures that are incapable of supporting and absorbing the large forces involved in a friction stir welding process. Accordingly, the back-up member is usually supported by a substantial support structure.

One apparatus for FSW is shown in FIGS. 1a and 1b. As shown in FIG. 1a, two workpieces (e.g., workpieces, 10A′, and 10B′), are aligned so that edges of the workpieces 10A′ and 10B′ to be welded together are held in direct contact on a backing workpiece 12′. A FSW tool W′ has a shoulder 14′ at its distal end, and a non-consumable welding pin 16′ extending downward centrally from the shoulder 14′. As the rotating tool W′ is brought into contact with the interface between workpieces 10B′ and 10A′, the pin 16′ is forced into contact with the material of both workpieces 10B′ and 10A′, as shown. The rotation of the pin 16′ in the material produces a large amount of frictional heating of both the welding tool pin 16′ and at the workpiece interface. The heating tends to soften the material of the workpieces 10A′ and 10B′ in the vicinity of the rotating pin 16′, thereby inducing a commingling of material from the two workpieces 10A′ and 10B′ to form a weld.

Because of the limitations in the thicknesses and types of materials that can be joined using FSW and the high temperatures and high stresses involved with FSW, there is a need to improve the properties of the welded joint across a broader range of welding applications. In addition, many problems arise when workpieces having different properties or formed of different materials are joined; therefore, improvements in the FSW process are needed.

### SUMMARY OF INVENTION

In one aspect, the present invention relates to an apparatus for use in friction stir welding including a friction stir tool, having a shoulder, a non-consumable welding pin extending downward centrally from the shoulder, a first workpiece disposed on a backing workpiece, a second workpiece located a predetermined distance from the first workpiece on the backing workpiece, and a transition strip disposed on the backing workpiece between the first workpiece and the second workpiece, wherein the contact area or a space between the transition strip and the first workpiece defines a first interface and the contact area or a space between the transition strip and the second workpiece defines a second interface, wherein the non-consumable welding pin is rotated over the first interface and the second interface to weld the first workpiece to the second workpiece with the transition strip material incorporated as part of the weld.

Other aspects and advantages of the invention will be apparent from the following description and the appended claims.

### BRIEF DESCRIPTION OF DRAWINGS

FIG. 1a shows one view of a prior art apparatus for friction stir welding.

FIG. 1b shows an alternate view of the prior art apparatus for friction stir welding shown in FIG. 1a.

FIG. 2 shows a side view of an embodiment of a friction stir welding apparatus in accordance with one embodiment of the present invention.

FIG. 3 shows a side view of an embodiment of a friction stir welding apparatus in accordance with one embodiment of the present invention.

FIGS. 4a-4d show relative thicknesses of a transition strip, a first workpiece, and a second workpiece in accordance with embodiments of the present invention.

FIGS. 5a-5b show side views of a non-planar transition strip, a first workpiece and a second workpiece in accordance with embodiments of the present invention.

FIG. 6 shows a top view of an embodiment of a friction stir welding apparatus in accordance with one embodiment of the present invention.

FIG. 7 shows a top view of an embodiment of a friction stir welding apparatus in accordance with one embodiment of the present invention.

FIG. 8 shows a top view of an embodiment of a friction stir welding apparatus in accordance with one embodiment of the present invention.

FIG. 9 shows a top view of an embodiment of a friction stir welding apparatus in accordance with one embodiment of the present invention.

FIGS. 10a-c show multiple transition strips between a first workpieces and a second workpiece in accordance with embodiment of the present invention.

FIG. 11 shows a side view of an embodiment of a friction stir welding apparatus in accordance with one embodiment of the present invention.

FIGS. 12a-12c shows a side view of an embodiment of a friction stir welding apparatus in accordance with one embodiment of the present invention.

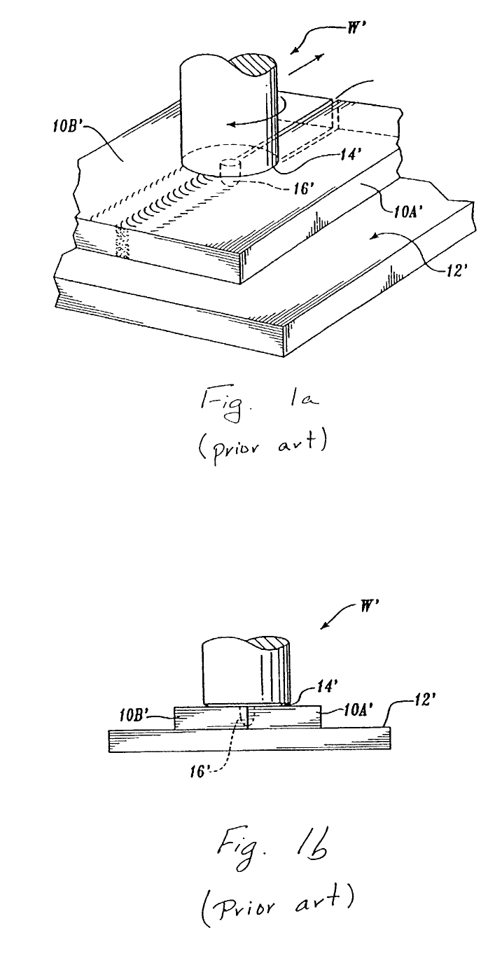

### DETAILED DESCRIPTION

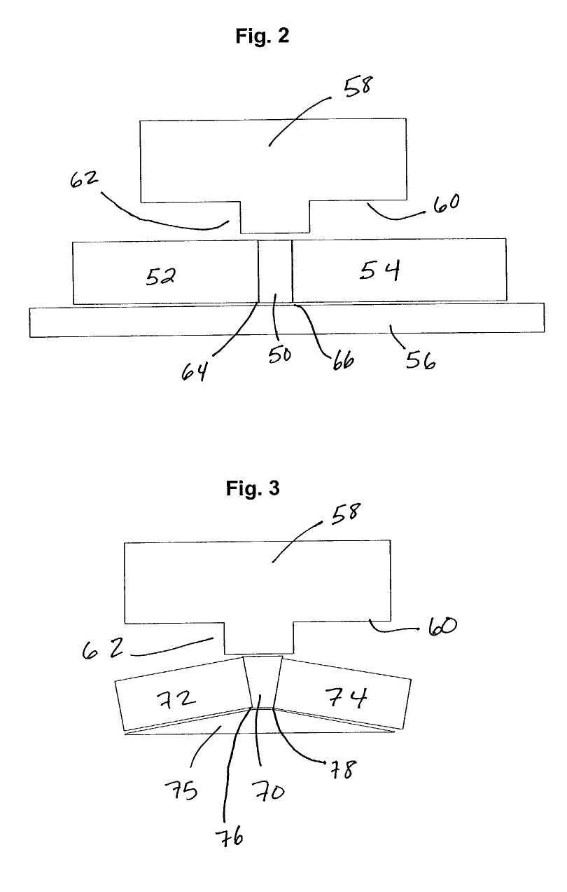

The present invention relates to the methods and apparatus for use when joining materials by friction stir welding (FSW). Similar elements described with respect to a particular Figure are given the same reference numerals when described with reference to another Figure. FIG. 2 shows one embodiment of the present invention.

In FIG. 2, a transition strip 50 is disposed between a first workpiece 52 and a second workpiece 54. As shown in FIG. 2, workpieces 52 and 54 are aligned so that edges of the workpieces to be welded together are disposed adjacent to the transition strip 50. Depending on the width and placement of the transition strip 50, there may or may not be a “gap” between an edge of the transition strip 50 and workpieces 52 and 54. The transition strip 50 and the workpieces 52 and 54 are disposed on a backing workpiece 56. An FSW tool 58 has a shoulder 60 at its distal end, and a non-consumable welding pin 62 extending downward centrally from the shoulder 60. The FSW tool 58 is then rotated about an axis and placed over both a first interface 64 between the first workpiece 52 and the transition strip 50 and a second interface 66 between the second workpiece 54 and the transition strip 50. As the FSW tool 58 is rotated, the pin 62 is brought into contact with the material of first and second workpieces 52 and 54 and the transition strip 50. The rotation of the pin 62 in the material produces a large amount of frictional heating of both the welding tool pin 62 and at the interfaces 64 and 66.

Frictional heating at the interfaces 64 and 66 tends to soften the material of the workpieces 52 and 54 and the transition strip 50 in the vicinity of the pin 62, thereby causing a commingling of material from the workpieces 52 and 54 and the transition strip 50 to form a weld. The tool is moved longitudinally over the interfaces 64 and 66 between the workpieces 52 and 54 and transition strip 50, thereby forming an elongate weld along the first and second interfaces 64 and 66. The shoulder 60 prevents softened material from the workpieces 52 and 54 from escaping upwards and forces the material into the weld joint. When the weld is completed, the FSW tool 58 is retracted. Incorporating a transition strip into the FSW process may speed the welding process, improve weld strength, allow for welding of dissimilar metals, among other advantages.

Importantly, the transition strip material is incorporated into the weld, which allows the transition strip material to be used as a delivery system for various materials. For example, in some instances it may be useful to provide “hard” particles such as tungsten carbide or boron nitride into the weld. The transition strip material could be designed to contain such particles. As another example, it may be desirable to incorporate fibrous material into the workpieces. Again, the transition strip may be designed to “deliver” this material into the weld as it is incorporated through the motion of the FSW tool.

FIG. 3 shows another embodiment of the present invention. In FIG. 3, a non-rectangular transition strip 70 is disposed between a first workpiece 72 and a second workpiece 74. As shown in FIG. 3, workpieces 72 and 74 are aligned so that edges of the workpieces 72 and 74 to be welded together are disposed adjacent to the non-rectangular non-rectangular transition strip 70. The non-rectangular transition strip 70 and the workpieces 72 and 74 are disposed on a backing workpiece 75. The use of a non-rectangular transition strip 70 allows a user to more easily join angled workpieces, i.e., when a user is joining workpieces at a corner. Additional angled support may be used with the backing workpiece so as to provide for angled frictional stir welding.

An FSW tool 58 has a shoulder 60 at its distal end, and a non-consumable welding pin 62 extending downward centrally from the shoulder 60. The FSW tool 58 is then rotated about an axis and placed over both a first interface 76 between the first workpiece 72 and the non-rectangular transition strip 70 and a second interface 78 between the second workpiece 74 and the non-rectangular transition strip 70. As the FSW tool 58 is rotated, the pin 62 is brought into contact with the material of first and second workpieces 72 and 74 and the transition strip 50. The rotation of the pin 62 in the material produces a large amount of frictional heating of both the welding tool pin 62 and at the interfaces 76 and 78.

As described above, the frictional heating at the interfaces 76 and 78 tends to soften the material of the workpieces 72 and 74 and the non-rectangular transition strip 70 in the vicinity of the pin 62, thereby causing a commingling of material from the workpieces 72 and 74 and the transition strip 70 to form a weld. The tool is moved longitudinally over the interfaces 76 and 78 between the workpieces 72 and 74 and non-rectangular transition strip 70, thereby forming an elongate weld along the first and second interfaces 76 and 78. The shoulder 60 prevents softened material from the workpieces 72 and 74 from escaping upwards and forces the material into the weld joint. When the weld is completed, the FSW tool 58 is retracted. With respect to the non-rectangular transition strip 70, the cross-section of the transition strip may have a bulge on a top and/or bottom, a depression on top and/or bottom, a bulge on one or both sides, depression on one or both sides, or any combination of the proceeding. In addition, there is no requirement for the transition strip to be a regular polygon, i.e., the transition strip may be asymmetric depending on a user's particular needs.

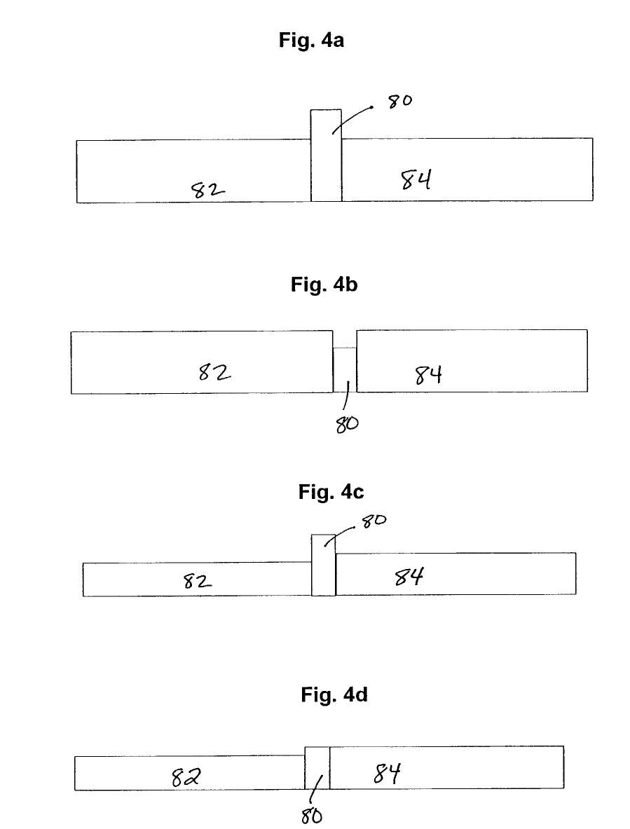

FIGS. 4a-4d show additional embodiments of the present invention. In FIGS. 4a-4d, a transition strip 80 is disposed between a first workpiece 82 and a second workpiece 84. In these embodiments, a thickness of the transition strip 80 is varied such that the transition strip 80 has a different thickness than at least one of the workpieces 82 and 84. As shown in FIGS. 4a-4d, the transition strip 80 may have a cross-sectional thickness larger than both workpieces 82 and 84, the transition strip 80 may have a cross-sectional thickness smaller than both workpieces 82 and 84, the transition strip 80, the first workpiece 82, and the second workpiece 84 may all have different thicknesses, or the transition strip 80 and one of the workpieces 82 and 84 may have the same thickness, which is different than the other workpiece. The workpieces 82 and 84 and the transition strip 80 are welded as described above. In addition, a non-rectangular transition strip 80 may be used as described with reference to FIG. 3, above. Varying the thickness of the plates and transition strip may speed the welding process and/or improve weld strength.

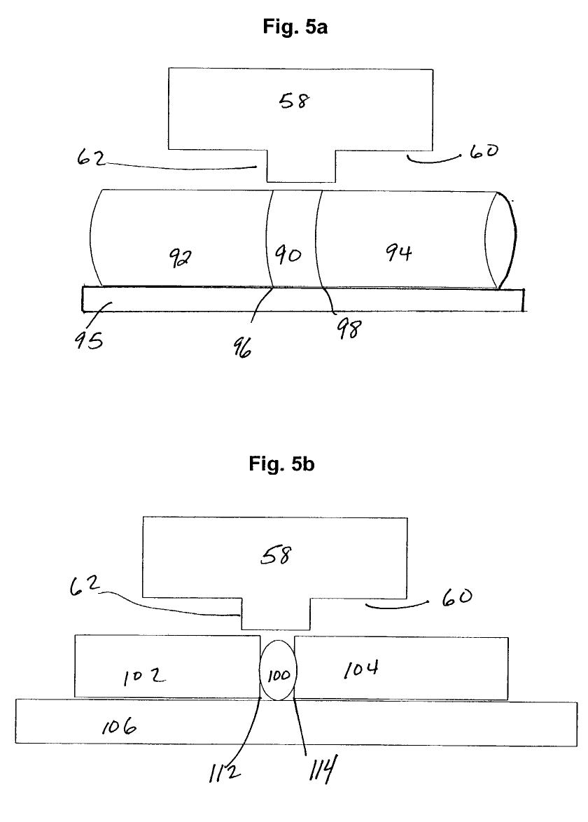

The above descriptions discuss planar surfaces, but the present invention is not limited to planar surfaces. It is expressly within the scope of the present invention that non-planar surfaces may be used. FIGS. 5a and 5b illustrate embodiments using non-planar surfaces and/or non-rectangular transition strips. In FIG. 5a, a non-planar transition strip 90 is disposed between a first non-planar workpiece 92 and a second non-planar workpiece 94. As shown in FIG. 5a, non-planar workpieces 92 and 94 are aligned so that edges of the non-planar workpieces 92 and 94 to be welded together are disposed adjacent to the non-planar transition strip 90. The non-planar transition strip 90 and the non-planar workpieces 92 and 94 are disposed on a backing workpiece 95. The use of a non-planar transition strip 90 allows a user to more easily join non-planar workpieces, i.e., when a user is joining curved workpieces.

A FSW tool 58 has a shoulder 60 at its distal end, and a non-consumable welding pin 62 extending downward centrally from the shoulder 60. The FSW tool 58 is then rotated about an axis and placed over both a first non-planar interface 96 between the first non-planar workpiece 92 and the non-planar transition strip 90 and a second non-planar interface 98 between the second non-planar workpiece 94 and the non-planar transition strip 90. As the FSW tool 58 is rotated, the pin 62 is brought into contact with the material of first and second non-planar workpieces 92 and 94 and the non-planar transition strip 90. The rotation of the pin 62 in the material produces a large amount of frictional heating of both the welding tool pin 62 and at the interfaces 96 and 98.

As described above, the frictional heating at the interfaces 96 and 98 tends to soften the material of the non-planar workpieces 92 and 94 and the non-planar transition strip 90 in the vicinity of the pin 62, thereby causing a commingling of material from the non-planar workpieces 92 and 94 and the non-planar transition strip 90 to form a weld. The tool is moved longitudinally over the interfaces 96 and 98 between the non-planar workpieces 92 and 94 and non-planar transition strip 90, thereby forming an elongate weld along the first and second interfaces 96 and 98. The shoulder 60 prevents softened material from the non-planar workpieces 92 and 94 from escaping upwards and forces the material into the weld joint. When the weld is completed, the FSW tool 58 is retracted.

Using a transition strip allows non-similar materials to be welded more easily than without a transition strip. The transition strip may, for example, serve as a compound having intermediate properties to the two workpieces being joined. Consequently, while the first and the second workpieces may be difficult to join directly, use of a transition strip enables the first and second workpieces to be joined.

FIG. 5b shows another embodiment of the present invention. In FIG. 5b, a non-rectangular transition strip 100 is disposed between a first workpiece 102 and a second workpiece 104. As shown in FIG. 5b, workpieces 102 and 104 are aligned so that edges of the workpieces to be welded together are disposed adjacent to the non-rectangular transition strip 100. The non-rectangular transition strip 100 and the workpieces 102 and 104 are disposed on a backing workpiece 106.

A FSW tool 58 has a shoulder 60 at its distal end, and a non-consumable welding pin 62 extending downward centrally from the shoulder 60. The FSW tool 58 is then rotated about an axis and placed over both a first interface 112 between the first workpiece 102 and the non-rectangular transition strip 100 and a second interface 114 between the second workpiece 104 and the non-rectangular transition strip 100. As the FSW tool 58 is rotated, the pin 62 is brought into contact with the material of first and second workpieces 102 and 104 and the non-rectangular transition strip 100. The rotation of the pin 62 in the material produces a large amount of frictional heating of both the welding tool pin 62 and at the interfaces 112 and 114. As described above, the motion of the tool causes the commingling of the transition strip and workpieces.

The above embodiments show a transition plate disposed between the first and second workpieces prior to friction stir welding. However, it is expressly within the scope of the present invention that the transition strip may be placed into position during friction stir welding. For example, a “coil” of transition strip material may be used. In this example, the coil is “unrolled,” i.e., the transition strip “wire” is placed into position as the FSW tool moves along the surface of the workpieces. By doing this, the transition plate does not have to be placed into position prior to friction stir welding.

It should be noted that the transition strip and the workpieces described in the above embodiments need not be formed from the same material. Depending on a particular user's requirements, the workpieces and transition strip may be formed from the same material, the workpieces may be formed of one material and the transition strip of a different material, the transition strip and one of the workpieces may be the same and the other workpiece different, or both workpieces and the transition strip may be different.

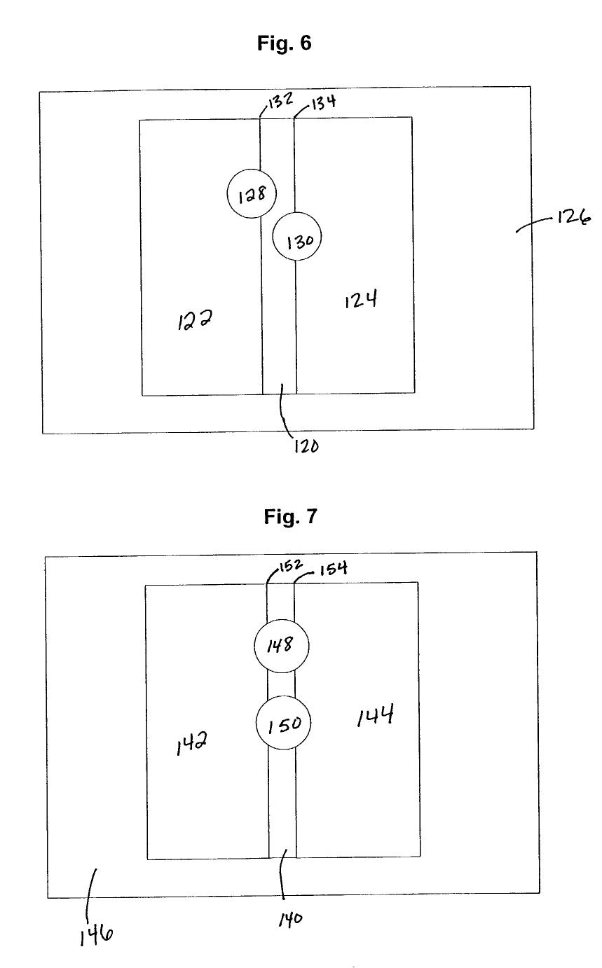

FIG. 6 shows another embodiment of the present invention, in which multiple tool heads, offset from one another are used. Offsetting the multiple tool heads on either side of a transition strip may result in better “mixing” of the workpieces and transition strip. The multiple tool heads may rotate in either the same or opposite directions.

In FIG. 6, a transition strip 120 is disposed between a first workpiece 122 and a second workpiece 124. As shown in FIG. 6, workpieces 122 and 124 are aligned so that edges of the workpieces to be welded together are disposed adjacent to the transition strip 120. The transition strip 120 and the workpieces 122 and 124 are disposed on a backing workpiece 126. In this embodiment, multiple rotating tool heads 128 and 130 are coupled to a FSW tool (not shown). Each of the multiple rotating tool heads 128 and 130 has a shoulder (not shown) at its distal end, and a non-consumable welding pins (not shown) extending downward centrally from the shoulder.

As the FSW tool (not shown) is rotated, the multiple rotating tool heads 128 and 130 are brought into contact with first interface 132 between the first workpiece 122 and the transition strip 120, and second interface 134 between the second workpiece 124 and the transition strip 120, respectively. The pins (not shown) of the multiple rotating tool heads 128 and 130 are brought into contact with the transition strip 120 and workpieces 122 and 124. As a result, the rotation of the pins (not shown) in the material produces a large amount of frictional heating, which results in the welding of both the first workpiece 122 and the second workpiece 124 to the transition strip 120 at the same time.

While the above description references multiple tool heads, multiple FSW tools may be used as well. In addition, the multiple tool heads may rotate in the same or opposite directions. Further, the multiple tool heads may be offset from one another or travel substantially parallel to one another.

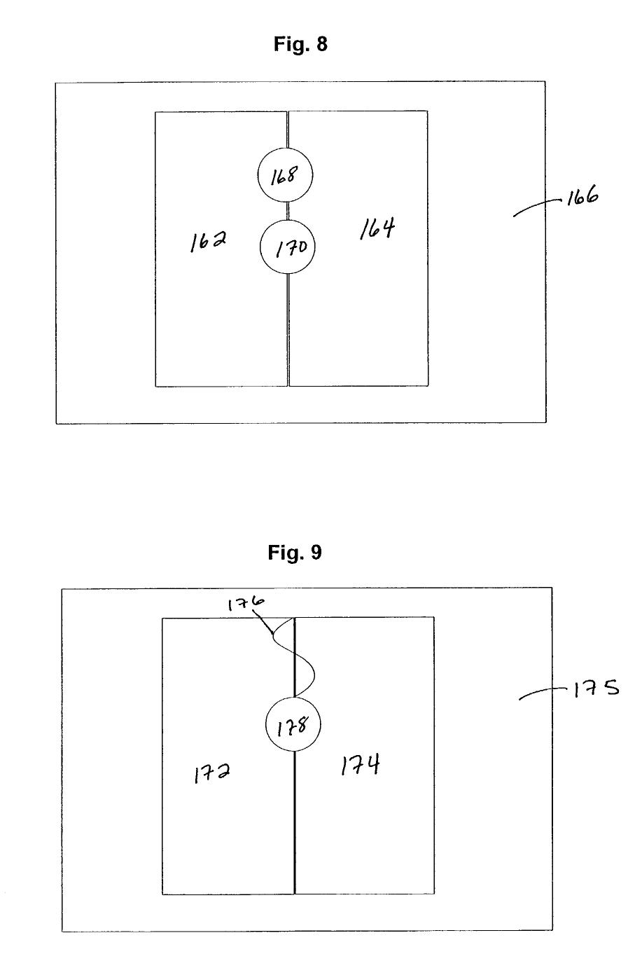

FIG. 7 illustrates an alternative embodiment of the present invention using a plurality of rotating tool heads. In FIG. 7, a transition strip 140 is disposed between a first workpiece 142 and a second workpiece 144. As shown in FIG. 8, workpieces 142 and 144 are aligned so that edges of the workpieces to be welded together are disposed adjacent to the transition strip 140. The transition strip 140 and the workpieces 142 and 144 are disposed on a backing workpiece 146. In this embodiment, multiple rotating tool heads 148 and 150 are coupled to a FSW tool (not shown). Each of the multiple rotating tool heads 148 and 150 has a shoulder (not shown) at its distal end, and a non-consumable welding pins (not shown) extending downward centrally from the shoulder. In this embodiment, the multiple rotating tool heads 148 and 150 are disposed such that they follow substantially the same path. Both of the multiple rotating tool heads 148 and 150 pass over the transition strip 140 and the workpieces 142 and 144. Additionally, with this embodiment, the transition strip 140 is not required, and the illustrated multiple tool head configuration may be used two join two adjacent workpieces absent a transition strip, depending on a user's particular requirements. FIG. 8 shows such an arrangement.

In FIG. 8, workpieces 162 and 164 are aligned so that edges of the workpieces to be welded together are disposed adjacent to one another. The workpieces 162 and 164 are disposed on a backing workpiece 166. In this embodiment, multiple rotating tool heads 168 and 170 are coupled to a FSW tool (not shown). Each of the multiple rotating tool heads 168 and 170 has a shoulder (not shown) at its distal end, and a non-consumable welding pins (not shown) extending downward centrally from the shoulder. In this embodiment, the multiple rotating tool heads 168 and 170 are disposed such that they follow substantially the same path. Both of the multiple rotating tool heads 168 and 170 pass over the workpieces 162 and 164.

Referring now to FIG. 7, as the FSW tool (not shown) is rotated, the multiple rotating tool heads 148 and 150 are brought into contact with both the first interface 152 between the first workpiece 142 and the transition strip 140, and second interface 154 between the second workpiece 144 and the transition strip 140. The pins (not shown) of the multiple rotating tool heads 148 and 150 are brought into contact with the transition strip 140 and workpieces 142 and 144. As a result, the rotation of the pins (not shown) in the material produces a large amount of frictional heating, which results in the welding of both the first workpiece 142 and the second workpiece 144 to the transition strip 140.

In this embodiment, the multiple tool heads 148 and 150 may provide different functions. For example, in one embodiment, one of the multiple tool heads could provide a “coarse” weld, while another of the multiple tool heads could pass over the “coarse” weld, creating a “finished” weld. Alternatively, one of the multiple tool heads could pre-heat the interface between the first and second workpieces, reducing wear on the other multiple tool heads used. In addition, while reference has been made two a two-head system, it is expressly within the scope of the present invention that more tool heads could be used as needed.

In another embodiment, the FSW tool may weld one workpiece to the transition strip, independent of a second workpiece. This may be useful when joining workpieces of different strengths. For example, the pressure required in order to weld one workpiece to the transition strip, if applied to the second workpiece, might deform the second workpiece. In such a case, the first workpiece may be welded to the transition strip, any changes to the FSW tool can be made, and the second workpiece may be welded to the transition strip. By using this method, therefore, workpieces of disparate properties may be welded together.

In another embodiment, motions in addition to the rotary motion and transverse travel in the direction of the weld may be imposed on the FSW tool. In particular, it is expressly within the scope of the present invention that the FSW tool may include up and down reciprocating motion (to allow welding of materials thicker than can now be joined using “conventional” FSW or material having different thicknesses), side-to-side motions, percussive motions and/or front-to-back motions. Superimposition of at least one motion in addition to rotation, improves material flow and increases the rate of friction stir welding. The additional motion or motions, increases the amount of energy being transmitted to the workpieces, resulting in the workpieces reaching the plasticized state more quickly. The superimposed motion may be used with the transition plate described above, but also may be used to improve material flow and increase the rate of “conventional” friction stir welding.

In another embodiment, a FSW tool may have a non-parallel path with respect to the seam to be welded together. FIG. 9 illustrates one such example. In FIG. 9, workpieces 172 and 174 are aligned so that edges of the workpieces 172 and 174 to be welded together are disposed adjacent to one another. The workpieces 172 and 174 are disposed on a backing workpiece 175.

An FSW tool 178 has a shoulder (not shown) at its distal end, and a non-consumable welding pin (not shown) extending downward centrally from the shoulder. The FSW tool 178 is then rotated about an axis. The FSW tool 178 then moves longitudinally along a non-parallel path, as depicted in FIG. 9, where the curved line 176 trailing the FSW tool 178 represents the prior path of the FSW tool 178. The non-parallel nature of the FSW tool's 178 path may improve the mixing and/or the rate of the weld. As the FSW tool 178 is rotated, the pin is brought into contact with the material of first and second workpieces 172 and 174. As discussed above, the movement of the FSW 178 results in the creation of a weld between the workpieces 172 and 174. Moreover, this embodiment may be combined with a transition strip as discussed in the above embodiments.

In another embodiment, a transition strip is heated prior to friction stir welding. Heat may be applied by any means known in the art. For example, heat may be applied through conductive heating of the transition strip prior to friction stir welding. Alternatively, if the transition strip is arranged in a coil, the transition strip coil may be heated prior to disposing the heated transition strip in between the workpieces. Alternatively, the workpieces may be heated, or both the workpieces and the transition strip may be heated.

In another embodiment, the workpieces, absent a transition strip may be heated prior to friction stir welding. Heating the transition strip reduces wear on the FSW tool caused by the generation of frictional heat used to raise the temperature of the transition strip to achieve the plasticized state. In addition to reducing wear, heating the transition strip prior to friction stir welding speeds the welding process because less time is required to raise the transition strip to the plasticized state. In an alternative embodiment, heat is applied not only to the transition strip but to the edges of the workpieces adjacent to the transition strip. The workpieces may be heated to the same temperature as the transition strip or a different temperature, depending on the particular application. In an alternative embodiment, heat may be applied only to the edges of the workpieces, prior to the insertion of a transition strip.

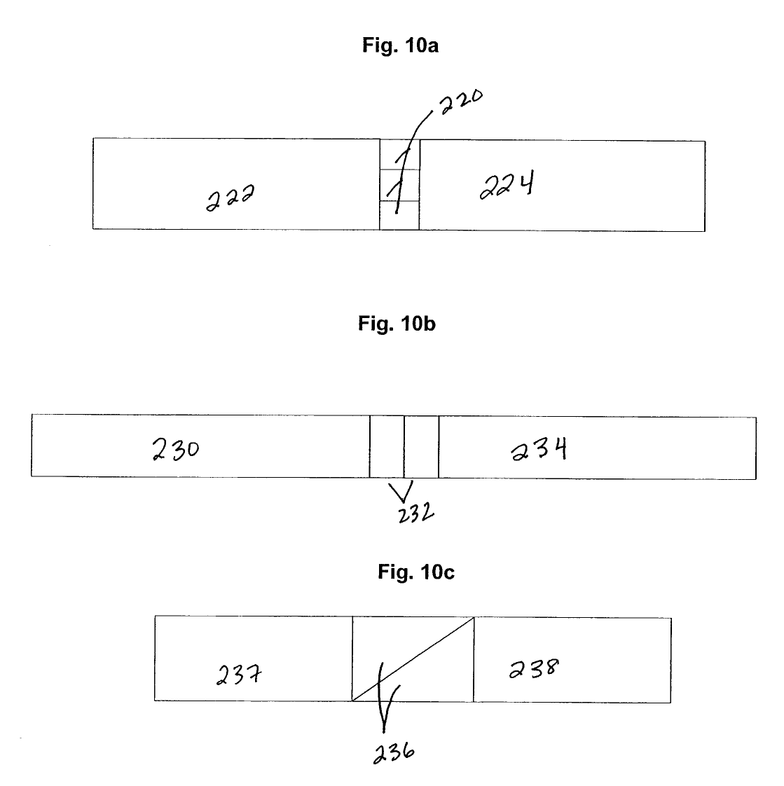

FIGS. 10a-10c show other embodiments of the present invention. In FIG. 10a, a plurality of transition strips 220 are disposed on top of one another between a first workpiece 222 and a second workpiece 224. The plurality of transition strips 220 are useful for welding together thick workpieces. Flow control may be improved by using a plurality of transition strips rather than using a single thick transition strip. FIG. 10b shows an alternative embodiment of the present invention. In FIG. 10b, a plurality of transition strips 232 are disposed side-by-side between a first workpiece 230 and a second workpiece 234. Arranging the plurality of transition strips 232 in this fashion may provide stronger welds when the workpieces are formed of different materials. The plurality of transition strips 232 may provide a range from hard to soft material, for example. FIG. 10c illustrates another embodiment using multiple transition strips. In FIG. 10c, a plurality of transition strips 236 are disposed between a first workpiece 237 and a second workpiece 238.

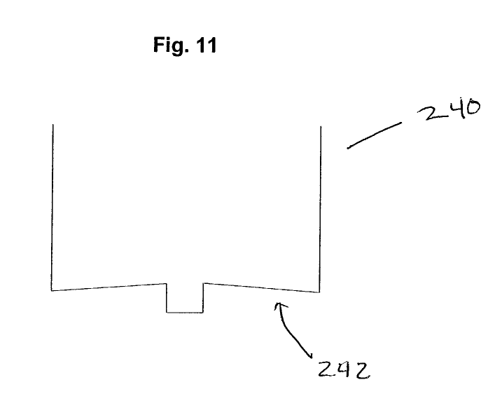

In FIG. 11, a FSW tool 240 is shown. The FSW tool 240 has a shoulder 242 having a surface which may be tapered toward or tapered away from the workpieces (not shown). The slight sloping assists in controlling flow, but is not so sloped as to dramatically reduce surface contact with workpieces (not shown). As the FSW tool 240 is rotated, the tapered shoulder 242 acts like a concrete trowel, by allowing excess plasticized material to fill into the gap between the surface and the tapered shoulder 242, which is then cleared away by the tapered shoulder 242 at the edges, where the tapered shoulder 242 directly contacts the workpieces. In addition, the tapered shoulder 242 may provide additional cooling capacity as air can flow underneath the surface of the FSW tool 240 more easily because of the gap between the surface of the workpieces and the shoulder 242. While a linear taper has been shown, the taper may also be arcuate in nature.

In another embodiment, an inert gas is passed over the surface of the workpieces during friction stir welding. The inert gas, such as nitrogen, helps to prevent oxidation of the workpieces during friction stir welding. Because of the heat and pressures used in friction stir welding, many metal materials undergo an oxidation reaction during friction stir welding. The resulting metal oxide may be significantly more brittle than the base metal, resulting in a weaker weld. By passing an inert gas over the surface being welded, the oxidation reaction can be reduced, simply by depriving the metal of oxygen, necessary for the reaction. Gas can be passed over the surface through the friction stir welding tool itself, or by any suitable method. Additionally, the inert gas may be used with any of the above described embodiments, including those using transition strips.

In another embodiment, a mechanical roller is rolled over an interface between the workpieces or between the workpieces and the transition strip. The mechanical roller pre-stresses the interface. Pre-stressing the interface results in a stronger weld when the friction stir welding tool is passed over the interface.

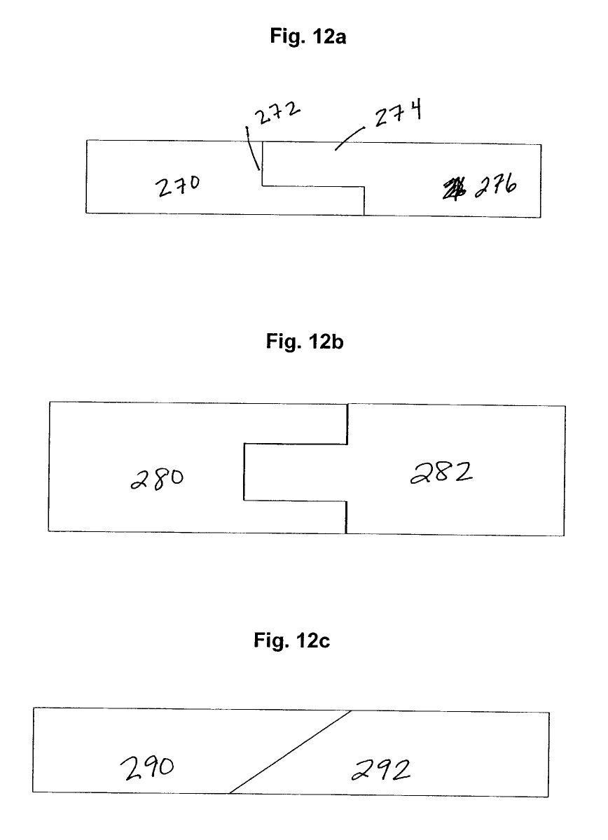

In other embodiments, shown in FIGS. 12a-12c, the workpieces comprise mating or interlocking surfaces. In FIG. 12a, a first workpiece 270 has a recessed groove 272 adapted to receive an extension 274 on a second workpiece 276. A FSW tool (not shown) is then passed over the interlocking surface, welding the workpieces 270 and 276 together. In FIG. 12b, an alternative interlocking structure is shown. In FIG. 12b, a first workpiece 280 and a second workpiece 282 are shown having an interlocking structure. In FIG. 12c, an alternative arrangement of mating surfaces is shown. In FIG. 12c, a first workpiece 290 and a second workpiece 292 are mated. Multiple FSW tool passes (i.e., the FSW tool may be passed over both a top and bottom surface of the workpieces) may be used in addition to the mating and/or interlocking surfaces in order to weld thick materials.

Advantageously, the present invention in at least some embodiments provides improved joint properties, facilitates the welding of workpieces with different properties, improves the flow of plasticized materials, reduces wear on FSW tools, facilitates welding corners and angles, and facilitates the welding of workpieces having differing thicknesses.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of friction stir welding comprising:
frictionally heating a transition strip, a first workpiece, and
a second workpiece, wherein the first workpiece and second workpiece are welded together, with the transition strip material incorporated as part of the weld, after application of the frictional force.

2. An apparatus for use in friction stir welding comprising:
a first workpiece disposed on a backing workpiece;
a second workpiece located a predetermined distance from the first workpiece on the backing workpiece; and
a transition strip disposed on the backing workpiece between the first workpiece and the second workpiece.

3. An apparatus for use in friction stir welding comprising:
a friction stir tool, having a shoulder;
a non-consumable welding pin extending downward centrally from the shoulder;
a first workpiece disposed on a backing workpiece;
a second workpiece located a predetermined distance from the first workpiece on the backing workpiece; and
a transition strip disposed on the backing workpiece between the first workpiece and the second workpiece, wherein the transition strip and the first workpiece defines a first interface and the transition strip and the second workpiece defines a second interface, wherein the non-consumable welding pin is rotated over the first interface and the second interface to weld the transition strip to the first workpiece and the second workpiece.

4. A method of friction stir welding comprising:
pre-heating a first workpiece;
pre-heating a second workpiece; and
frictionally heating the first workpiece and the second workpiece, wherein the first workpiece and second workpiece are welded together after application of frictional force.

5. A method of friction stir welding comprising:
passing an inert gas over a surface of a first workpiece and a second workpiece; and
frictionally heating the first workpiece and the second workpiece, wherein the first workpiece and second workpiece are welded together after application of frictional force.

6. An apparatus for use in friction stir welding comprising:
a friction stir tool, having a plurality of rotating tool heads, each of the plurality of rotating tool heads having a shoulder, the shoulder having a non-consumable pin extending downward centrally from the shoulder;
a first workpiece disposed on a backing workpiece;
a second workpiece located a predetermined distance from the first workpiece on the backing workpiece; and
a transition strip disposed on the backing workpiece between the first workpiece and the second workpiece, wherein the transition strip and the first workpiece defines a first interface and the transition strip and the second workpiece defines a second interface, wherein the non-consumable welding pin is rotated over the first interface and the second interface to weld the transition strip to the first workpiece and the second workpiece.

7. A method of friction stir welding comprising:
superimposing a motion on a friction stir welding tool; and
frictionally heating a first workpiece and a second workpiece, wherein the first workpiece and second workpiece are welded together after application of frictional force.

8. An apparatus for use in friction stir welding comprising:
a friction stir tool, having a tapered shoulder;
a non-consumable welding pin extending downward centrally from the tapered shoulder;
a first workpiece disposed on a backing workpiece;
a second workpiece located a predetermined distance from the first workpiece on the backing workpiece; and
a transition strip disposed on the backing workpiece between the first workpiece and the second workpiece, wherein the transition strip and the first workpiece defines a first interface and the transition strip and the second workpiece defines a second interface, wherein the non-consumable welding pin is rotated over the first interface and the second interface to weld the transition strip to the first workpiece and the second workpiece.

9. An apparatus for use in friction stir welding comprising:
a friction stir tool, having an arcuate shoulder;
a non-consumable welding pin extending downward centrally from the arcuate shoulder;
a first workpiece disposed on a backing workpiece;
a second workpiece located a predetermined distance from the first workpiece on the backing workpiece; and
a transition strip disposed on the backing workpiece between the first workpiece and the second workpiece, wherein the transition strip and the first workpiece defines a first interface and the transition strip and the second workpiece defines a second interface, wherein the non-consumable welding pin is rotated over the first interface and the second interface to weld the transition strip to the first workpiece and the second workpiece.

10. An apparatus for use in friction stir welding comprising:
a friction stir tool, having a shoulder;
a non-consumable welding pin extending downward centrally from the shoulder;
a first workpiece disposed on a backing workpiece;
a second workpiece located a predetermined distance from the first workpiece on the backing workpiece; and
a transition strip disposed on the backing workpiece between the first workpiece and the second workpiece, wherein the transition strip and the first workpiece defines a first interface and the transition strip and the second workpiece defines a second interface, wherein the non-consumable welding pin is rotated in a non-parallel path over the first interface and the second interface to weld the transition strip to the first workpiece and the second workpiece.
